(19) United States
(12) Patent Application Publication
(10) Pub. No.: US 2023/0373293 A1
(43) Pub. Date: Nov. 23, 2023

(54) VEHICLE LID DEVICE

(71) Applicant: TOYODA GOSEI CO., LTD., Kiyosu-shi (JP)

(72) Inventors: Kenichiro KANEKO, Kiyosu-shi (JP); Kazuki FUJISAWA, Nagoya-shi (JP)

(21) Appl. No.: 18/319,715

(22) Filed: May 18, 2023

(30) Foreign Application Priority Data
May 23, 2022 (JP) 2022-084086

(51) Int. Cl. B60K 15/05; E05D 3/12

(52) U.S. Cl. CPC B60K 15/05; E05D 3/125; B60K 2015/053; E05Y 2900/534

(57) ABSTRACT

This vehicle lid device includes: a box attached to a vehicle-body side surface portion, and including a storage space storing a vehicle-energy supply port, a communication hole for the storage space and a vehicle-body deep side to communicate with each other, and an opening for exposing the supply port to a vehicle-body outside; a lid to open/close between opening-closed/opened positions; and an open/close mechanism interposed between the box and the lid, for opening/closing the lid relative to the box about an axis line on an upper-periphery side of the opening. The open/close mechanism includes a plate-shaped hinge arm extending in a direction including an axial direction of the axis line, and covering a box-lid gap formed above the opening in a lid-opened state. Both axial-direction ends of the hinge arm are respectively located on axial-direction outer sides relative to axial-direction periphery ends of the supply port or the communication hole.

### TECHNICAL FIELD

The present invention relates to a vehicle lid device.

### BACKGROUND ART

Conventionally, there has been known a vehicle lid device mounted to a vehicle (for example, JP2012-76606(A)). The vehicle lid device is a device that opens/closes, by a lid, an opening of a box storing a supply port for supplying energy to a vehicle. The box is located on a vehicle-body deep side. The opening of the box communicates with the vehicle-body outside through a vehicle-body opening, and allows the supply port to be exposed to the vehicle-body outside. The lid is opened/closed via a hinge between a closed position where the opening is closed and an opened position where the opening is opened. The hinge is interposed between the box and the lid, and allows the lid to open/close relative to the box about an axis line provided on the upper-periphery side of the opening.

The vehicle lid device includes a cover member for covering the opening when the lid is at an opened position or the lid is being opened/closed. The cover member is formed in a plate shape or a sheet shape. At the opened position of the lid, the cover is located so as to connect a peripheral portion on three sides other than the hinge side of the lid and a periphery other than an upper periphery of the opening. Thus, the cover member prevents raindrop from entering the supply port inside the opening from outside of the opening when the lid is at the opened position or is being opened/closed.

### SUMMARY OF INVENTION

### Technical Problem

However, in the above vehicle lid device described in JP2012-76606(A), the hinge is composed of a pair of arms separated on the left and right sides as seen from the front side of the lid. In this hinge structure, when the lid is opened, a gap between the box and the lid is exposed to outside, between the pair of arms above the opening. Therefore, in this hinge structure, when the lid is opened, rainwater or the like falling on a vehicle body part above a vehicle-body side surface portion to which the box is attached or the surface of the opened lid, directly drops to the supply port in the opening through the gap from the outer side of the upper periphery of the opening without being blocked, so that water may come into contact with the supply port.

The present invention has been made in view of the above circumstances, and an object of the present invention is to provide a vehicle lid device that prevents water from dropping to a supply port when a lid is opened.

### Solution to Problem

One aspect of the present invention is a vehicle lid device including: a box attached to a vehicle-body side surface portion, and including a storage space storing a supply port for supplying energy to a vehicle, a communication hole through which the storage space and a vehicle-body deep side communicate with each other, and an opening that allows the supply port to be exposed to a vehicle-body outside; a lid configured to open/close between a closed position where the opening is closed and an opened position where the opening is opened; and an open/close mechanism interposed between the box and the lid, and configured to cause the lid to open/close relative to the box about an axis line provided on an upper-periphery side of the opening. The open/close mechanism includes a hinge arm extending in a plate shape in a direction including an axial direction in which the axis line extends, the hinge arm being configured to cover a gap, between the box and the lid, formed above the opening when the lid is opened. Both ends in the axial direction of the hinge arm are respectively located on outer sides in the axial direction relative to periphery ends in the axial direction of the supply port or the communication hole.

This configuration prevents water from dropping to a supply port when a lid is opened.

### BRIEF DESCRIPTION OF DRAWINGS

FIG. 1 is a perspective view showing a lid closed state after a vehicle lid device according to one embodiment of the present invention is attached to a vehicle body;

FIG. 2 is a perspective view showing a lid opened state of the vehicle lid device of the present embodiment;

FIG. 3 is an exploded perspective view from one side before the vehicle lid device of the present embodiment is attached to the vehicle body;

FIG. 4 is an exploded perspective view from another side before the vehicle lid device of the present embodiment is attached to the vehicle body;

FIG. 5 is a front view (shown in A) and a side view (shown in B) of the vehicle lid device of the present embodiment at a lid closed position;

FIG. 6 is a front view (shown in A) and a side view (shown in B) of the vehicle lid device of the present embodiment at a lid opened position;

FIG. 7 illustrates operation of a latch mechanism portion of an open/close mechanism provided to the vehicle lid device of the present embodiment;

FIG. 8 is a lid back view showing a stored state of a cover member of an open/close mechanism provided to a vehicle lid device according to one modification;

FIG. 9 is a perspective view showing the lid opened state of the vehicle lid device of the modification; and

FIG. 10 is a block configuration diagram of the control device provided to the vehicle lid device of the modification.

### DESCRIPTION OF EMBODIMENTS

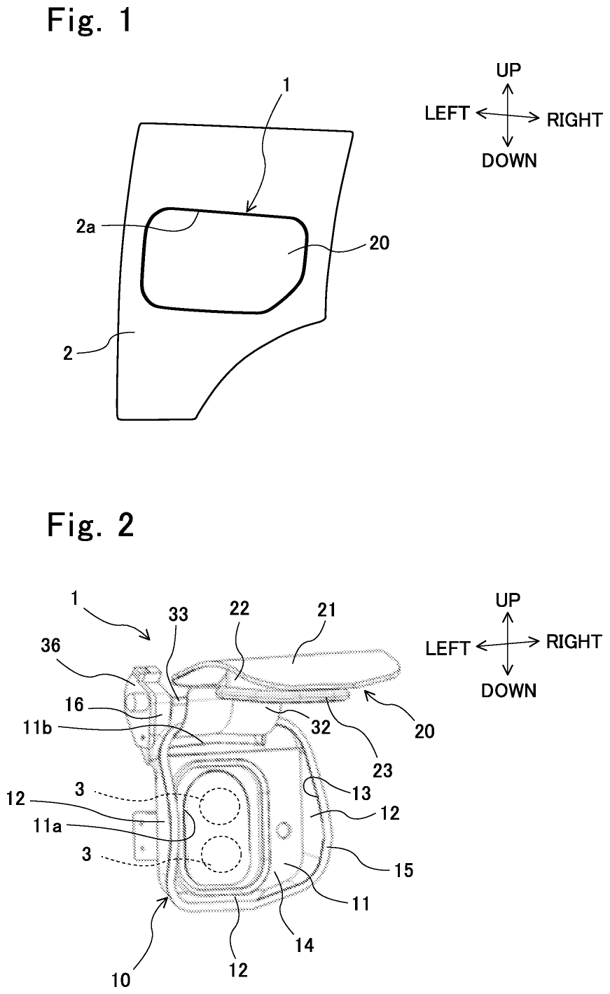

Hereinafter, with reference to FIG. 1 to FIG. 10, specific embodiments and modifications of a vehicle lid device according to the present invention will be described.

A vehicle lid device 1 of one embodiment is a device that opens/closes a lid for opening/closing a vehicle-body opening provided to a vehicle. The vehicle lid device 1 is mounted to a vehicle such as a gasoline vehicle, a diesel vehicle, an electric vehicle, or a hybrid vehicle.

As shown in FIG. 1, the vehicle has a vehicle-body side surface portion 2 such as a vehicle-body left/right surface, a vehicle-body forward surface, or a vehicle-body rearward surface. The vehicle-body side surface portion 2 is provided with a vehicle-body opening 2a. In the vehicle-body opening 2a, supply ports 3 (indicated by broken lines in FIG. 2) for supplying energy to the vehicle are placed. The vehicle-body opening 2a penetrates the vehicle body in a front-back direction which is an inner-outer direction.

Each supply port 3 is a fuel port for refueling or a charge port for battery charging. The supply port 3 is provided so as to be exposed to the vehicle-body outside via the vehicle-body opening 2a in a lid opened state. The supply port 3 is provided at an end of a fuel supply pipe or an electric wire. Another end of the fuel supply pipe or the electric wire is connected to a fuel tank, a battery, or the like provided on a vehicle-body deep side (i.e., vehicle-body inner side). A refueling gun, a charging gun, or the like for supplying energy is connectable to the supply port 3 in a cap opened state. For a purpose such as protection from dust and water, the supply port 3 may be covered by a cap that is openable/closable by being manually operated by an operator.

The vehicle lid device 1 includes a box 10, a lid 20, and an open/close mechanism 30. Hereinafter, directions (e.g., left/right) and arrangements are shown with reference to a state as seen from the front surface side of the lid 20.

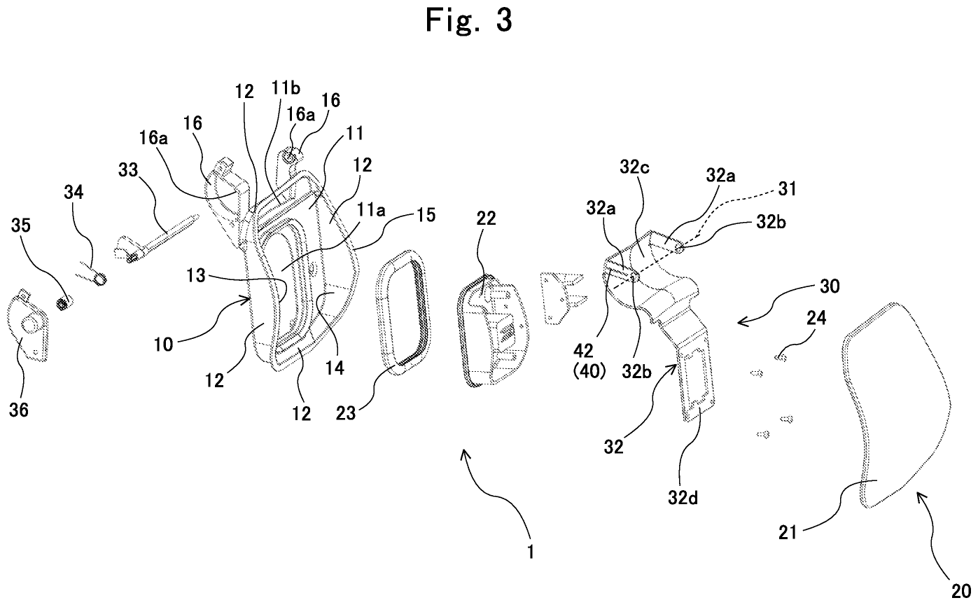

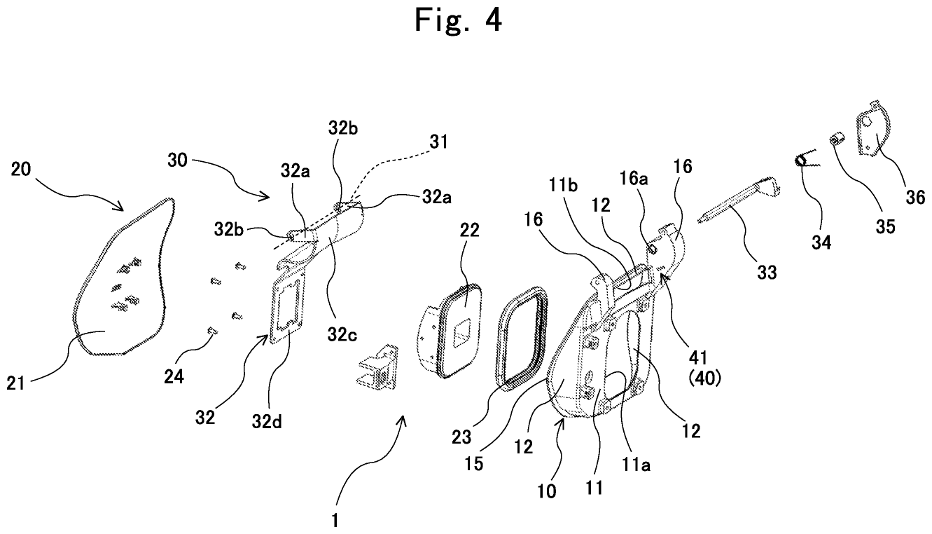

The box 10 is a box body storing the supply ports 3. The box 10 is provided on the vehicle-body deep side of the vehicle-body side surface portion 2 so as to be fitted to the vehicle-body opening 2a. As shown in FIG. 2, FIG. 3, and FIG. 4, the box 10 includes one bottom wall 11, four peripheral walls 12, an opening 13, and a storage space 14.

The bottom wall 11 is a part extending in a quadrangular plate shape. Each peripheral wall 12 is connected to the periphery of the bottom wall 11, and the four peripheral walls 12 are wall parts erected from the periphery of the bottom wall 11 so as to surround the bottom wall 11. The bottom wall 11 and the peripheral walls 12 form the storage space 14 storing the supply ports 3. The bottom wall 11 has a communication hole 11a. The communication hole 11a is a passage through which the storage space 14 and the vehicle-body deep side of the bottom wall 11 communicate with each other and a fuel supply pipe or an electric wire is led, and is a through hole needed for storing the supply ports 3 in the storage space 14. The communication hole 11a is provided at the center of the bottom wall 11. The supply ports 3 are exposed to the vehicle-body outside through the opening 13 and the vehicle-body opening 2a when the lid is opened in a state in which the supply ports 3 are stored in the storage space 14.

The opening 13 is provided to the box 10. The opening 13 is provided on a side opposite to the bottom wall 11 across the storage space 14. The opening 13 is opened/closed by the lid 20. The opening 13 is closed when the lid 20 is at a closed position, and is opened when the lid 20 is not at the closed position. When the opening 13 is opened, the opening 13 exposes the supply ports 3 in the storage space 14 to the vehicle outside. The box 10 is attached to the vehicle-body side surface portion 2 such that the opening 13 faces in the horizontal direction or slightly obliquely upward from the horizontal direction.

The box 10 includes a frame 15. The frame 15 is formed in an annular shape along the periphery of the opening 13 at protruding ends of the peripheral walls 12. The frame 15 is formed in a flange shape so as to extend in a frame-outward direction from the periphery of the opening 13. The box 10 is positioned at the vehicle-body side surface portion 2 by the back surface of the frame 15 contacting with the vehicle-body opening periphery of the vehicle-body side surface portion 2 or the like, for example.

The box 10 has a drain hole (not shown). The drain hole is a hole through which water accumulated at the bottom of the storage space 14 is drained to outside of the storage space 14, i.e., the box 10. The drain hole is provided at a lowermost part of a wall (e.g., the peripheral wall 12 or the boundary between the peripheral wall 12 and the bottom wall 11) forming the bottom of the storage space 14, and penetrates the wall in the up-down direction. Water that has entered the storage space 14 and has reached the bottom thereof is drained to outside of the box 10 through the drain hole.

The lid 20 is a lid member for covering the opening 13 of the box 10. The lid 20 is openable/closable between the closed position (specifically, fully closed position) where the opening 13 is closed and an opened position (specifically, fully opened position) where the opening 13 is opened. The lid 20 is supported so as to be pivotable relative to the box 10. The lid 20 is formed in a plate shape. The lid 20 is formed in a size and a shape (e.g., substantially rectangular shape) corresponding to the opening 13. At the closed position of the lid 20, the lid 20 closes the opening 13 while contacting with the frame 15 on the periphery of the opening 13 or the peripheral portion of the vehicle-body opening 2a of the vehicle-body side surface portion 2. The surface of the lid 20 may be curved correspondingly to the surface shape of the vehicle-body side surface portion 2 or the like.

The lid 20 is openable/closable between the closed position and the opened position through manual operation by an operator. The lid 20 is allowed to be locked at the closed position by a lock member (not shown). In addition, the lid 20 is opened by a biasing force of a spring 34 described later when a lock release operation (e.g., wire pulling operation) is performed in a locked state at the closed position. The lid 20 may be opened/closed using a drive force of a motor or the like, instead of manual operation by an operator.

The lid 20 includes a lid body 21 and a lid inner member 22. The lid body 21 is a plate portion to be flush with the vehicle-body side surface portion 2 at the closed position of the lid 20. The lid inner member 22 is a part for covering the communication hole 11a of the bottom wall 11 of the box 10 at the closed position of the lid 20. The lid inner member 22 contacts with the front surface of the bottom wall 11 of the box 10 via an annular gasket 23, when covering the communication hole 11a. The lid inner member 22 is integrated with the lid body 21 via a hinge arm 32 described later. For example, as shown in FIG. 3 and FIG. 4, the lid inner member 22 is screwed to the back surface side of the hinge arm 32 using screws 24. Then, the hinge arm 32 is fitted and fixed to the back surface side of the lid body 21.

The open/close mechanism 30 is a mechanism for opening/closing the lid 20 relative to the box 10 about an axis line 31, between the closed position and the opened position, and is a so-called gooseneck type. The open/close mechanism 30 is interposed between the box 10 and the lid 20. The open/close mechanism 30 causes the lid 20 to open upward. As shown in FIG. 3 and FIG. 4, the open/close mechanism 30 includes the hinge arm 32, a shaft member 33, the spring 34, and a damper 35.

The hinge arm 32 is a member for opening/closing the lid 20 relative to the box 10, integrally with the lid 20. The hinge arm 32 is pivotable about the axis line 31. The axis line 31 is a line extending in the left-right direction, and is a pivot center line of the hinge arm 32 and a rotation center line of the shaft member 33. The axis line 31 may extend in the horizontal left-right direction or may be inclined relative to the horizontal direction. The axis line 31 is provided on the upper-periphery side of the opening 13 of the box 10. Specifically, the axis line 31 extends in the left-right direction above the upper periphery of the opening 13, in a space on the vehicle-body deep side of the vehicle-body side surface portion 2.

The hinge arm 32 extends in a plate shape in directions including the axial direction in which the axis line 31 extends. The hinge arm 32 has a surface including both of the axial direction of the axis line 31 and a radial direction crossing the axis line 31, and extends in an arm shape with the axis line 31 as a base. The hinge arm 32 has a support leg 32a. The support leg 32a is an arm-shaped support portion connecting the axis line 31 and the body of the hinge arm 32. A pair of the support legs 32a are provided separately from each other in the axial direction.

Each support leg 32a has a fixation hole 32b for fixing the shaft member 33 described later. The fixation hole 32b is provided at one end of the support leg 32a. The shaft member 33 is fixed to the fixation holes 32b at both ends in the axial direction, so as to be integrated with the support legs 32a and therefore the hinge arm 32. Each support leg 32a extends toward the vehicle-body deep side from the fixation hole 32b side. Another end of each support leg 32a is connected to the body of the hinge arm 32. The body of the hinge arm 32 is formed in a curved shape so as not to interfere with the box 10 or the like when the lid 20 is opened/closed. The body of the hinge arm 32 is formed to be wide in the axial direction.

The bottom wall 11 of the box 10 has a through hole 11b other than the communication hole 11a. The through hole 11b is a hole through which the hinge arm 32 penetrates. The through hole 11b is provided above the communication hole 11a in the bottom wall 11. The through hole 11b is formed in a rectangular shape corresponding to the axial-direction width of the hinge arm 32. The axial-direction width of the through hole 11b is such a width that does not cause interference with the hinge arm 32 at a peripheral part around the through hole 11b, and is any width greater than the axial-direction width of the body of the hinge arm 32. The hinge arm 32 penetrates the through hole 11b from the axis line 31 and protrudes to the storage space 14 side.

The hinge arm 32 covers a gap, between the box 10 and the lid 20, formed above the opening 13 when the lid 20 is opened. The hinge arm 32 has a penetrating plate portion 32c. The penetrating plate portion 32c is a part, of the hinge arm 32, located on the axis line 31 side and penetrating the through hole 11b. The penetrating plate portion 32c is formed in a wide plate shape so as to be continuous in the axial direction without gaps. The penetrating plate portion 32c covers the gap between the box 10 and the lid 20 from the lower side of the gap continuously, when the lid 20 is opened/closed between the closed position and the opened position and when the lid 20 is at the opened position.

The penetrating plate portion 32c is formed in such a size that covers a range occupied in the axial direction by each supply port 3. That is, the axial-direction width of the penetrating plate portion 32c is not less than the axial-direction width of the supply port 3 and is preferably greater than the width-direction width of the supply port 3. The penetrating plate portion 32c is provided above the supply port 3 so as to cover the axial-direction range of the supply port 3. That is, both ends in the axial direction of the penetrating plate portion 32c are respectively located on the outer sides in the axial direction relative to the periphery ends in the axial direction of the supply port 3. Specifically, both ends of the penetrating plate portion 32c are located at the same positions in the axial direction as the periphery ends of the supply port 3 or on the outer sides in the axial direction relative to the periphery ends.

Regarding widths and arrangements, the “supply port 3” may include not only the supply port 3 itself as a space but also a cylindrical member forming the periphery of the supply port 3. In this regard, for example, the “axial-direction width of the supply port 3” may be the axial-direction width of the supply port 3 itself or may be the width between outer periphery ends in the axial direction of the cylindrical member forming the periphery of the supply port 3.

The penetrating plate portion 32c may be formed in a shape not sloped relative to the axial direction, between the closed position and the opened position, including the opened position of the lid 20. However, the penetrating plate portion 32c may be sloped from one end side to another end side in the axial direction, or may be sloped downward from the center to both end sides in the axial direction.

The hinge arm 32 includes a lid attachment portion 32d. The lid attachment portion 32d is a part to be attached to the lid body 21. The lid attachment portion 32d is provided at a protruding end of the hinge arm 32. The lid attachment portion 32d is provided such that the front surface thereof is along the back surface of the lid body 21, and is fitted and fixed to the back surface side of the lid body 21. The lid 20 is opened/closed by pivoting about the axis line 31 of the hinge arm 32. The lid inner member 22 is attached to the back surface side of the lid attachment portion 32d using the screws 24.

The shaft member 33 is an axial body forming the axis line 31. The shaft member 33 is provided in a space on the back side of the vehicle-body side surface portion 2, and extends in the left-right direction above the upper periphery of the opening 13. The shaft member 33 is fixed to the fixation holes 32b of the support legs 32a of the hinge arm 32 so as to be integrated with the hinge arm 32. The shaft member 33 rotates about the axis line 31 integrally with the hinge arm 32.

The box 10 includes a support portion 16 rotatably supporting the shaft member 33. The support portion 16 protrudes upward from the peripheral wall 12 or the bottom wall 11 at an upper part of the box 10. A pair of the support portions 16 are provided separately from each other in the left-right direction. The pair of support portions 16 have axial holes 16a opposed to each other in the axial direction. Both ends of the shaft member 33 are inserted into the pair of axial holes 16a. The shaft member 33 is supported so as to be rotatable relative to the support portion 16.

The spring 34 is a spring member generating a biasing force for biasing the lid 20 toward the opened position from the closed position. The spring 34 is externally fitted to the shaft member 33. One end of the spring 34 is supported by the shaft member 33. Another end of the spring 34 is supported on the box 10 side (specifically, support portion 16). The spring 34 transfers the biasing force to the shaft member 33, thereby pivoting the hinge arm 32 and therefore opening the lid 20. The biasing force of the spring 34 is maximum at the closed position of the lid 20 and is minimum at the opened position (fully opened position) of the lid 20. From a state in which the lid 20 is locked at the closed position, when the lock is released through lock release operation or the like, the lid 20 is opened by the biasing force of the spring 34.

The damper 35 is a member for reducing the speed when the lid 20 is opened. The damper 35 is provided on the axis of the shaft member 33. The damper 35 is covered by a damper cover 36 from the axial direction. The damper 35 reduces the speed of the lid 20 using, for example, the viscosity of oil, when the lid 20 is opened.

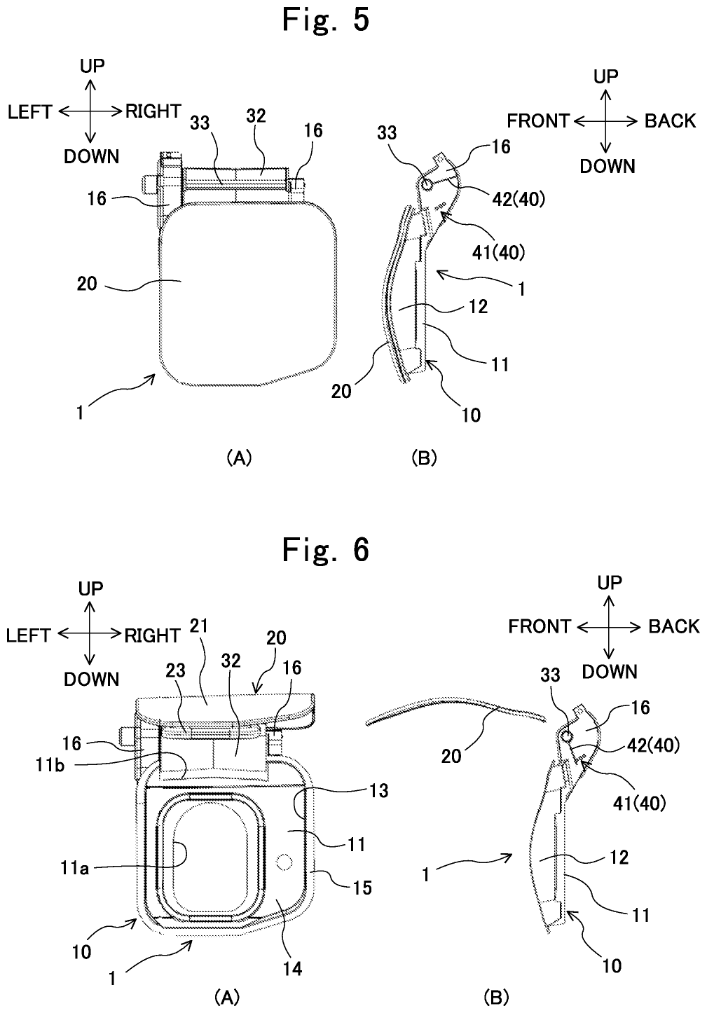

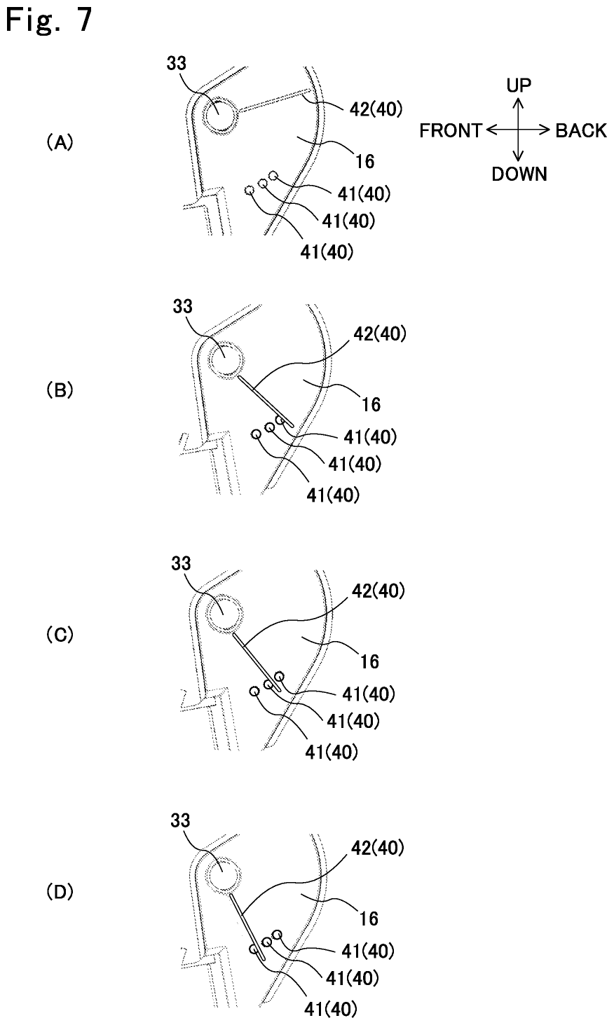

As shown in FIG. 3, FIG. 4, FIG. 5, FIG. 6, and FIG. 7, the open/close mechanism 30 includes a latch mechanism portion 40. The latch mechanism portion 40 is a mechanism for retaining the lid 20 at a predetermined opening angle between the closed position and the opened position. The latch mechanism portion 40 includes a box-side adjustment portion 41 provided on the box 10 side and a lid-side adjustment portion 42 provided on the lid 20 side. The box-side adjustment portion 41 and the lid-side adjustment portion 42 are engageable with each other to retain the lid 20 at a predetermined opening angle between the closed position and the opened position against the biasing force of the spring 34.

The box-side adjustment portion 41 is a projecting portion projecting inward in the axial direction so as to be contactable with the lid 20 side (specifically, lid-side adjustment portion 42) when the lid 20 is opened/closed. The box-side adjustment portion 41 may be provided to at least one of the pair of support portions 16 of the box 10. The box-side adjustment portion 41 is located, on the axial-direction inner surface of the support portion 16, at a position that is away in the radial direction from the axial hole 16a and is on a movement trajectory of the lid-side adjustment portion 42 during lid opening/closing operation.

The latch mechanism portion 40 allows adjustment of the opening angle at which the lid 20 is retained among a plurality of angles. That is, a plurality of the box-side adjustment portions 41 (in the present embodiment, three box-side adjustment portions 41) are provided. The plurality of box-side adjustment portions 41 are provided so as to be arranged separately from each other in the circumferential direction about the axial hole 16a. The number of the box-side adjustment portions 41 is set correspondingly to the number of opening angles at which the lid 20 is retained.

The lid-side adjustment portion 42 is a projecting portion projecting in the axial direction so as to be contactable with each box-side adjustment portion 41 when the lid 20 is opened/closed. The lid-side adjustment portion 42 is provided to the support leg 32a corresponding to the support portion 16 provided with the box-side adjustment portions 41, of the pair of support legs 32a of the hinge arm 32, for example. The lid-side adjustment portion 42 is located at a position away in the radial direction from the fixation hole 32b on the axial-direction outer surface of the support leg 32a. The lid-side adjustment portion 42 is provided in a linear shape so as to extend in the radial direction. The lid-side adjustment portion 42 sequentially comes into contact with each of the plurality of box-side adjustment portions 41 on the box 10 side through a process in which the opening angle changes during the opening/closing operation of the lid 20.

The position where the lid-side adjustment portion 42 and each box-side adjustment portion 41 contact with each other is such a position that entry of raindrop from the front surface side of the lid 20 into the storage space 14 is more prevented than at the lid opened position (i.e., fully opened position; e.g., opening angle 90°), and is a position where the opening angle of the lid 20 is smaller than at the opened position of the lid 20. Examples of such positions are positions where the opening angle is 65°, 75°, and 85° with reference to the closed position (opening angle) 0° of the lid 20.

When being subjected to the biasing force of the spring 34 from the closed position of the lid 20, the lid-side adjustment portion 42 is movable to the opened position of the lid 20 by riding over all the box-side adjustment portions 41 with an inertial force of the lid 20, although coming into contact with each box-side adjustment portion 41. Meanwhile, when an operator manually returns the opened lid 20 to the closed position side, the lid-side adjustment portion 42 is retainable in a state of being engaged with any box-side adjustment portion 41 against the biasing force of the spring 34. The operator is allowed to select the box-side adjustment portion 41 to be engaged with the lid-side adjustment portion 42 by adjusting the return position of the lid 20.

Next, operation of the vehicle lid device 1 will be described.

In the vehicle lid device 1, during traveling of the vehicle or the like, the lid 20 is at the closed position where the opening 13 of the box 10 is closed. In this case, the lid 20 is locked at the closed position by the lock member against the biasing force of the spring 34. At the closed position of the lid 20, the supply ports 3 in the storage space 14 of the box 10 are not exposed to the vehicle-body outside, and therefore connection of a refueling gun or a charging gun to the supply ports 3 is impossible.

In a case of desiring to perform refueling or battery charging of the vehicle at the closed position of the lid 20, an operator such as a vehicle driver or a vehicle user stops the vehicle and performs, on the vehicle, necessary work for opening the lid 20 to the opened position. This work includes a lock release operation of releasing the lock of the lid 20 at the closed position, and in accordance with the situation of the operator, for example, the operator having a smart key corresponding to the vehicle approaches the vehicle to cause the vehicle to perform matching through communication between the vehicle and a portable device; the operator performs an opening command by an application of a smartphone; the operator presses an open-switch button provided in the vehicle; or the operator pulls an open lever provided in the vehicle.

When the above work is performed, the lock of the lid 20 at the closed position is released and the lid 20 is opened. Specifically, when the lock of the lid 20 at the closed position is released, the shaft member 33 rotates by the biasing force of the spring 34 of the open/close mechanism 30, so that the hinge arm 32 pivots about the axis line 31. Thus, the lid 20 is opened about the axis line 31 from the closed position. Then, the lid 20 reaches the opened position.

In a case of desiring to return the lid 20 to the closed position after refueling or battery charging of the vehicle is completed, the operator manually closes the lid 20 to the closed position against the biasing force of the spring 34. When the lid 20 is closed and has reached the closed position, the lock member retains the lid 20 at the closed position. Thus, the lid 20 is locked at the closed position.

As described above, the vehicle lid device 1 allows the lid 20 to be opened/closed between the closed position and the opened position. This opening/closing operation of the lid 20 is performed about the axis line 31 extending in the left-right direction above the upper periphery of the opening 13. Thus, at the opened position of the lid 20, the lid body 21 of the lid 20 serves as an eave covering the opening 13 from above, whereby entry of water such as raindrop from above the opening 13 into the storage space 14 is prevented.

The open/close mechanism 30 includes the hinge arm 32. At the opened position of the lid 20, the penetrating plate portion 32c of the hinge arm 32 covers the gap, between the box 10 (specifically, the upper periphery of the opening 13) and the lid 20 (specifically, the periphery of the lid body 21 (more specifically, the upper periphery of the lid body 21 at the lid closed position)), formed on the upper side of the opening 13, from below the gap. The penetrating plate portion 32c is formed in a wide plate shape so as to be continuous in the axial direction without gaps. Then, both ends in the axial direction of the penetrating plate portion 32c are respectively located on the outer sides in the axial direction relative to the periphery ends in the axial direction of the supply ports 3.

In this structure, even in a case where raindrop or the like has entered the gap, between the box 10 and the lid 20, formed above the opening 13, and the water is led to both ends in the axial direction of the penetrating plate portion 32c of the hinge arm 32 and drops from both ends in the axial direction, the dropping of the water occurs on the outer sides in the axial direction of the range occupied in the axial direction by each supply port 3. Therefore, in the vehicle lid device 1, water entering through the gap, between the box 10 and the lid 20, formed above the opening 13 in the lid opened state is prevented from dropping to the supply ports 3. Thus, entry and contact of water to the supply ports 3 are prevented, so that entry of water into a fuel tank, short-circuit of the battery, or the like is avoided.

Even if water dropped from both ends in the axial direction of the penetrating plate portion 32c of the hinge arm 32 has entered the storage space 14, the water comes to the bottom of the storage space 14 without entering each supply port 3, and then is drained to the outside of the box 10 through the drain hole of the box 10. Thus, water is prevented from staying in the storage space 14 and a waterproof function of preventing entry and contact of water to the supply ports 3 is improved.

The open/close mechanism 30 includes the latch mechanism portion 40. The latch mechanism portion 40 is a mechanism that allows adjustment of the opening angle at which the lid 20 is retained. With this structure, the opening angle at which the lid 20 is retained is allowed to be smaller than at the opened position of the lid 20, whereby the retention position in the opened state of the lid 20 is allowed to be on the closed position side. Thus, entry of water such as raindrop into the storage space 14 at the opened position of the lid 20 is prevented, whereby the waterproof function for the supply ports 3 is further improved.

In the above embodiment, both ends in the axial direction of the hinge arm 32 of the open/close mechanism 30 are respectively located on the outer sides in the axial direction relative to the periphery ends in the axial direction of the supply ports 3. However, the present invention is not limited thereto. Both ends in the axial direction of the hinge arm 32 of the open/close mechanism 30 may be located on the outer sides in the axial direction relative to the periphery ends in the axial direction of the communication hole 11a of the box 10.

In general, the size of the communication hole 11a provided to the bottom wall 11 of the box 10 is larger than the sizes of the supply ports 3 stored in the storage space 14. Therefore, also in the structure in the above modification, even in a case where water having entered the gap, between the box 10 and the lid 20, formed above the opening 13 in the lid opened state drops from both ends in the axial direction of the penetrating plate portion 32c of the hinge arm 32, the dropping occurs on the outer sides in the axial direction of the range occupied in the axial direction by each supply port 3. Thus, the same effects as in the above embodiment are obtained.

In the above embodiment, the latch mechanism portion 40 of the open/close mechanism 30 includes the box-side adjustment portions 41 provided on the box 10 side (specifically, support portion 16) and the lid-side adjustment portion 42 provided on the lid 20 side (specifically, the support leg 32a of the hinge arm 32). However, the present invention is not limited thereto. The box-side adjustment portions 41 of the latch mechanism portion 40 may be provided at the periphery of the axial hole 16a and the lid-side adjustment portion 42 may be provided at the shaft member 33.

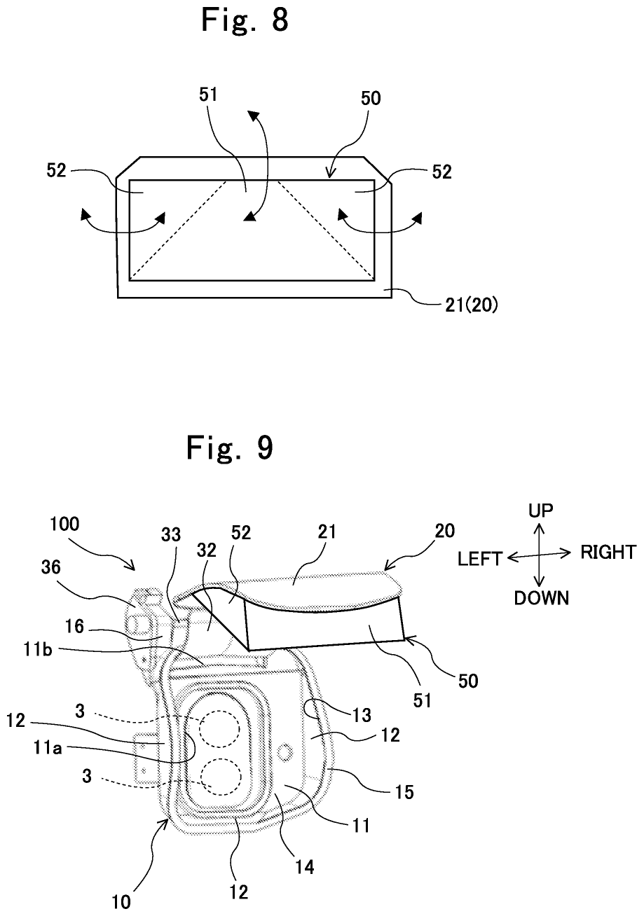

In the above embodiment, the hinge arm 32 of the open/close mechanism 30 is formed in a wide shape to prevent dropping of water to the supply ports 3. However, the present invention is not limited thereto. Further, in order to improve the waterproof function of preventing entry and contact of water to the supply ports 3, the open/close mechanism 30 may include a cover member 50 as shown in FIG. 8 and FIG. 9.

In the vehicle lid device 1 of this modification, the cover member 50 is a member for covering a part of the opening 13 at the opened position of the lid 20. Specifically, the cover member 50 covers at least a part of a gap, through which the storage space 14 is exposed, formed between the periphery of the lid body 21 and the periphery of the opening 13 at the opened position of the lid 20. The cover member 50 is formed in a plate shape or a sheet shape. The cover member 50 is attached to the back surface side of the lid 20. The cover member 50 is stored by being folded on the back surface side of the lid 20 at the closed position of the lid 20. In addition, the cover member 50 is expanded so as to cover the opening 13 from the back surface side of the lid 20 in a state in which the lid 20 is opened from the closed position to the opened position (i.e., when the lid 20 is being opened or in a state in which the lid 20 has reached the opened position).

As shown in FIG. 8 and FIG. 9, the cover member 50 includes a front cover portion 51 and two side cover portions 52. The cover member 50 may include either the front cover portion 51 or the side cover portions 52, or may include at least the side cover portions 52. The front cover portion 51 is a portion for covering at least a part of a gap between the lower periphery of the lid body 21 and the lower periphery of the opening 13 at the opened position of the lid 20. The front cover portion 51 is formed in a rectangular shape. The two side cover portions 52 are portions for covering at least parts of gaps between the left and right ends of the lid body 21 and the left and right ends of the opening 13 at the opened position of the lid 20. Each side cover portion 52 is formed in a triangular shape or a sector shape.

The front cover portion 51 and the side cover portions 52 are in a stored state of being folded on the back surface side of the lid 20 in a predetermined order, at the closed position of the lid 20. In the stored state, for example, as shown in FIG. 8, the cover portions 51, 52 are overlaid on each other by being folded such that each side cover portion 52 contacts with the back surface of the lid 20 and the two side cover portions 52 are sandwiched between the front cover portion 51 and the back surface of the lid 20. Conversely, in the stored state, the cover portions 51, 52 may be overlaid on each other by being folded such that the front cover portion 51 contacts with the back surface of the lid 20 and the front cover portion 51 is sandwiched between each side cover portion 52 and the back surface of the lid 20.

The cover member 50 is locked by a lock member (not shown) in the stored state at the closed position of the lid 20. The lock member allows the cover member 50 to be locked in the stored state or allows the lock to be released, through manual operation or switch operation by an operator. The lock of the cover member 50 in the stored state may be performed using a drive force of a motor or the like. The lock release of the cover member 50 in the stored state, i.e., expansion thereof, may be performed using the drive force of the motor or the like, or may be performed by the self-weight of the cover member 50 at any time during opening operation of the lid 20 or when the lid 20 has reached the opened position.

In the structure of this modification, during opening operation or at the opened position of the lid 20, the cover member 50 is expanded so as to cover the opening 13 from the back surface side of the lid 20 as shown in FIG. 9. With this structure, at the opened position of the lid 20, the front cover portion 51 covers at least a part of the gap between the periphery of the lid body 21 (more specifically, the lower periphery of the lid body 21 at the lid closed position) and the lower periphery of the opening 13, and the side cover portions 52 cover at least parts of the gaps between the left and right ends of the lid body 21 and the left and right ends of the opening 13. Thus, the amount of water entering the storage space 14 through the opening 13 from the outer side of the box 10 is reduced, whereby the waterproof function for water to the supply ports 3 is improved.

In the above modification, if the cover member 50 remains expanded when the lid 20 is closed from the opened position, the cover member 50 interferes with the box 10 or the vehicle-body side surface portion 2, so that the lid 20 is prevented from reaching the closed position, and further, the lid 20 or the vehicle-body side surface portion 2 is likely to be damaged.

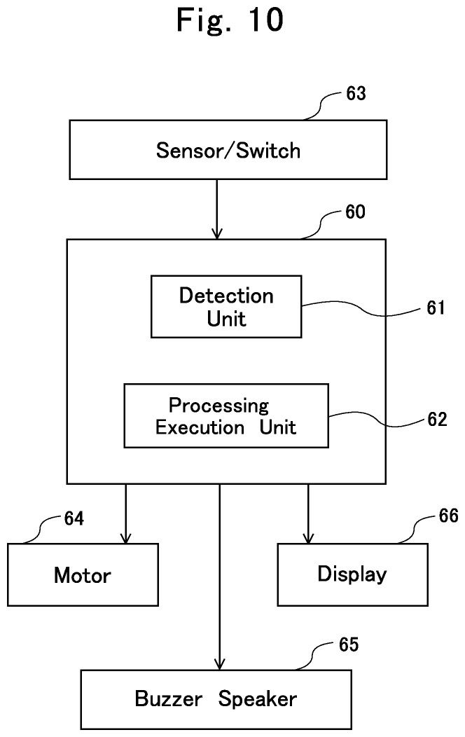

Accordingly, as shown in FIG. 10, the vehicle lid device 1 may include a control device 60 for performing necessary control when the lid 20 is opened/closed. When the lid 20 closes from the opened position toward the closed position, the control device 60 performs detection for a fact that the cover member 50 is not in the stored state, and if the control device 60 has detected the fact, the control device 60 executes processing of stopping the closing operation of the lid 20. The control device 60 is mainly composed of a microcomputer. The control device 60 may be provided near the box 10, or may be provided on the vehicle-body deep side separately from the box 10.

The control device 60 includes a detection unit 61 and a processing execution unit 62. The detection unit 61 performs detection for a fact that the cover member 50 is not in the stored state, when the lid 20 closes from the opened position toward the closed position. The detection unit 61 performs the above detection on the basis of a signal outputted from a sensor/switch 63 provided on the back surface side of the lid 20. Plural kinds of sensors/switches 63 may be provided, and examples of the sensor/switch 63 include a pressure sensor, a contact sensor, an angle sensor, a proximity sensor, and a camera. The sensor/switch 63 may be provided to the lid 20, or may be provided to the box 10.

When a fact that the cover member 50 is not in the stored state is detected during opening operation of the lid 20, the processing execution unit 62 executes closing operation stop processing of stopping closing operation of the lid 20. As the closing operation stop processing, the processing execution unit 62 causes a stopper member (not shown) to protrude so as to physically stop the closing operation performed by an operator, or performs warning or caution by sound or indication to the operator performing the closing operation.

The stop processing for the lid closing operation is executed by an electric signal supplied from the processing execution unit 62 to a motor 64. In accordance with a command from the processing execution unit 62, the motor 64 generates a drive force for causing the stopper member to protrude onto a movement trajectory of the lid 20 during the closing operation, thereby physically stopping the closing operation of the lid 20. The motor 64 may be provided near the shaft member 33 and may advance/retract the stopper member to/from a rotation trajectory of the shaft member 33.

The warning processing or the caution processing is executed by electric signals supplied from the processing execution unit 62 to a buzzer speaker 65 and a warning display 66. The buzzer speaker 65 outputs a warning sound or a caution message urging an operator closing the lid 20 to stop the closing operation, in accordance with a command from the processing execution unit 62. The warning display 66 performs warning indication or caution indication to urge the operator closing the lid 20 to stop the closing operation, in accordance with a command from the processing execution unit 62. The buzzer speaker 65 may be provided on the back surface side of the box 10. The warning display 66 may light up the peripheral portion of the box 10 or the lid 20 in red or may perform caution indication on the front surface of the lid 20.

With the configuration of this modification, when the lid 20 closes from the opened position toward the closed position, a fact that the cover member 50 is not in the stored state is detectable, and on the basis of the detection, during closing operation of the lid 20, the closing operation is forcibly stopped using the motor 64, or the operator is notified that the operator has neglected to store the cover member 50, using the buzzer speaker 65. Thus, the cover member 50, the box 10, the vehicle-body side surface portion 2, or the like is prevented from being damaged due to neglecting to store the cover member 50 at the time of closing the lid 20.

The present invention is not limited to the embodiments and the modifications described above, and various changes may be made without departing from the gist of the present invention.

The description of the present invention discloses not only technical features shown by the reference relationship of the claims at the time of filing of the present application but also technical features obtained by combining matters described in the claims as appropriate.

This application claims priority on Japanese Patent Application No. 2022-084086 filed in Japan on May 23, 2022, the entire contents of which are incorporated herein by reference.

1. A vehicle lid device comprising:
a box attached to a vehicle-body side surface portion, and including a storage space storing a supply port for supplying energy to a vehicle, a communication hole through which the storage space and a vehicle-body deep side communicate with each other, and an opening that allows the supply port to be exposed to a vehicle-body outside;
a lid configured to open/close between a closed position where the opening is closed and an opened position where the opening is opened; and
an open/close mechanism interposed between the box and the lid, and configured to cause the lid to open/close relative to the box about an axis line provided on an upper-periphery side of the opening, wherein
the open/close mechanism includes a hinge arm extending in a plate shape in a direction including an axial direction in which the axis line extends, the hinge arm being configured to cover a gap, between the box and the lid, formed above the opening when the lid is opened, and
both ends in the axial direction of the hinge arm are respectively located on outer sides in the axial direction relative to periphery ends in the axial direction of the supply port or the communication hole.

2. The vehicle lid device according to claim 1, wherein
the open/close mechanism includes a latch mechanism portion configured to retain the lid at a predetermined opening angle between the closed position and the opened position.

3. The vehicle lid device according to claim 1, wherein
the open/close mechanism includes a cover member attached to a back surface side of the lid, and
the cover member is stored on the back surface side of the lid at the closed position of the lid, and is expanded so as to cover the opening from the back surface side of the lid in a state in which the lid is opened from the closed position to the opened position.

4. The vehicle lid device according to claim 3, further comprising:
a detection unit configured to perform detection for a fact that the cover member is not in a stored state, when the lid closes from the opened position toward the closed position; and
a processing execution unit configured to execute processing of stopping closing operation of the lid when the detection unit has detected the fact.
